(19) United States
(12) Patent Application Publication
(10) Pub. No.: US 2006/0149932 A1
(43) Pub. Date: Jul. 6, 2006

(54) Data processing circuit, multiplier unit with pipeline, ALU and shift register unit for use in a data processing circuit

(75) Inventor: Johannes Roelof Gerardus de Vries, TD Zoetermeer (NL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Arcobel Graphics B.V., San Mateo, CA (US)

(21) Appl. No.: 11/347,194

(22) Filed: Feb. 2, 2006

Related U.S. Application Data
(62) Division of application No. 08/966,954, filed on Nov. 10, 1997, now abandoned.
Application No. 08/966,954 is a continuation of application No. 08/422,264, filed on Apr. 14, 1995, now abandoned.

(30) Foreign Application Priority Data
Apr. 15, 2004 (NL) 9400607

(51) Int. Cl. G06F 9/30

(52) U.S. Cl. 712/218

(57) ABSTRACT

The present invention provides a circuit of processing integer data, especially for graphic applications having a multiplier unit which includes a pipeline in which the word length is adjustable for multiplying integer data s words of 8 bits or multiples thereof an arithmetic logic unit (ALU) for performing arithmetic operations on integer data words, the word length of which is adjustable in 8 bits or multiples thereof; a register unit provided with at least two registers for storage of integer data words having multiples of 8 bits on which the operation and/or pipeline multiplication has to be performed; and a bus structure having a number of separate buses which effects the transport of integer data words from and to the multiplier unit, the arithmetic logic unit and the register unit.

### CROSS-REFERENCE TO RELATED APPLICATIONS

This application is a divisional of U.S. patent application Ser. No. 08/966,954, filed on Nov. 10, 1997 and entitled, “Data Processing Circuit, Multiplier Unit with Pipeline, ALU and Shift Register Unit for Use in a Data Processing Circuit” (hereinafter “the parent application”), which was a file wrapper continuation of U.S. patent application Ser. No. 08/422,264, filed on Apr. 14, 1995, which claims priority to Dutch patent application no. NL 9400607, filed on Apr. 15, 1994, all of which are incorporated herein by reference.

### BACKGROUND OF THE INVENTION

Nowadays a large number of personal computers make use of processors which have a complex instruction set (CISC). Such processors are provided with a central processing unit, the function of which is adjusted at each clock pulse to perform the desired operation on two operand words. These processors are currently commercially available under Intel code numbers beginning with 80.

Although the clock speed of the function adjustable processors has been increased considerably, the organizational structure of such a processor forms a great obstacle to further increase the processing speed. For instance, during multiplying and dividing of two operand words, frequent use must be made of registers internally present in the computer.

So-called work stations often use a pipeline structure with a reduced instruction set (the so-called RISC, Reduced Instruction Set Computer) in order to increase the speed of the work station. This structure provides an increase in speed of so-called vector operations, wherein a large number of data words have to be subjected to the same arithmetic operation. Since a limited instruction set can be implemented efficiently, the execution of a large number of instructions requires only a single clock pulse.

Although the RISC structure achieves an increase in speed for frequently occurring operations (such as multiplications) more complex instructions for particular operations are omitted from the instruction set and, therefore, the speed of executing such operations is not increased. In addition, the processing unit is often designed for data words with a fixed word length, for example 32 or 64 bits.

In EP-A-0173383, a processor for floating point operations is disclosed. Such floating point operations are not useful for image or graphical processing applications, where operations have to be performed on integer data words of 8, 16 or 32 bits.

In the article “The 1860TH 64-bit supercomputing microprocessor” by L. Kohn et al, published in the proceedings of supercomputing, 13-17 Nov. 1989, Reno, Nevada, VS, 1989, IEEE Computer Society Press, Washington D.C., a RISC based micro-processor for executing multiplications for either 64 bit or 32 bit words is described. As described above, such RISC concept does not provide for increased speed when integer data words of 8 bits or multiples thereof have to be processed.

Also, in EP-A-0380100, a multiplier is disclosed for processing 32 bit operands to provide two 16 bit by 16 bit fixed point products for one 32 bit floating point product during each clock cycle.

For image and/or graphics processing applications however, operations have to be performed on data words of 8 or 16 bits or a number of mutually associated bytes before even a limited speed increase is achieved in the RISC concept.

The present invention provides a data processing circuit comprising:

a multiplier unit for multiplying integer data words of 8 bits or multiples thereof having a pipeline and in which the word length is adjustable for multiplying the integer data words;

an arithmetic logic unit (ALU) having an adjustable word length for performing arithmetic operations on integer data words of 8 bits or multiples thereof;

a register unit provided with at least two registers for storing the integer data words of 8 bits or multiples of 8 bits on which the operation and/or pipeline multiplication has to be performed; and

a bus structure which comprises a number of separate buses and which effects the transport of integer data words from and to the multiplier unit, the arithmetic logic unit and the register unit.

The data processing unit according to the present invention achieves a speed, for graphic applications, that is more than twice as great as in existing systems. In contrast to RISC and CISC, the data flow between the above specified circuits (multiplier, ALU etc.) is not fixed. Rather, the programmer is free to program the sequence of the data flow through the different units (free pipeline).

The present invention further provides a multiplier unit with a pipeline for use in a data processing circuit.

The present invention also comprises an arithmetic logic unit for use in a data processing circuit.

Finally, the present invention provides a shift register unit for use in a data processing circuit.

### BRIEF DESCRIPTION OF THE DRAWINGS

Further advantages, features and details of the present invention will be elucidated on the basis of the following description of a preferred embodiment thereof with reference to the drawings, in which:

FIG. 1 is a functional diagram of a graphic application of a data processing circuit according to the present invention;

FIG. 2 shows an outline diagram of the data processing circuit of FIG. 1;

FIG. 3 shows a functional diagram of the internal structure of the data processing circuit of FIG. 1;

FIG. 4 shows a first functional diagram of the arithmetic logic unit of the diagram of FIG. 3;

FIG. 5 shows a second functional diagram of the arithmetic logic unit of the diagram of FIG. 3;

FIG. 6 shows a functional diagram of the multiplier unit with pipeline of the diagram of FIG. 3;

FIG. 7 shows a functional diagram of a Wallace tree in the diagram of FIG. 6; and

FIG. 8 shows a functional diagram of the shift register unit from the functional diagram of FIG. 3.

### DETAILED DESCRIPTION OF THE INVENTION

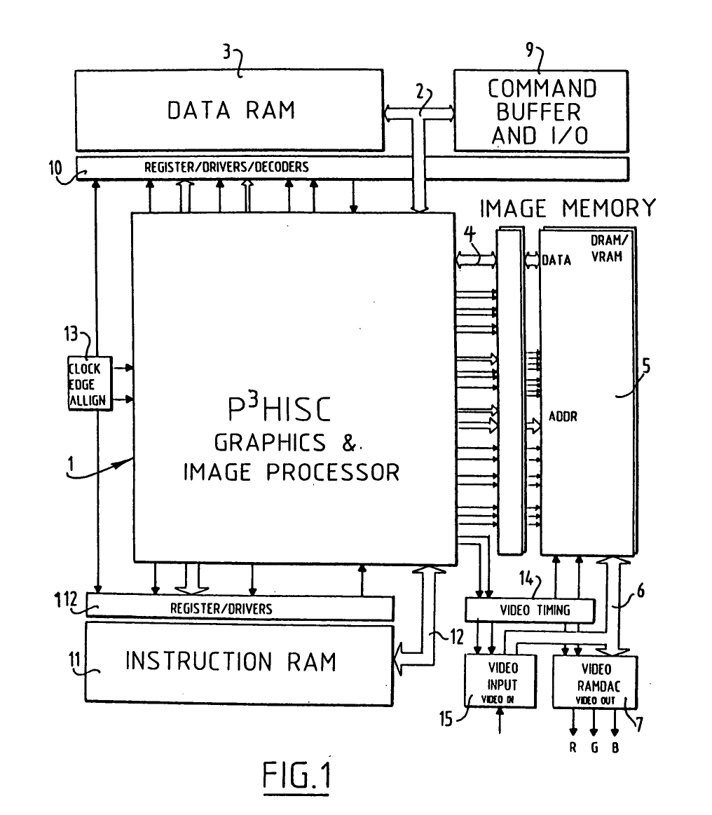

A data processing circuit 1 (FIG. 1) according to the present invention, also named DISC or IMAGINE, is coupled via a bus 2 to a data memory 3, for instance SRAM (Static Random Access Memory). The data processing circuit 1 is further connected via a bus 4 to a main or video memory 5 for storage of image data, which is constructed from DRAM (Dynamic Random Access Memory) cells or is a (more expensive) VRAM. This main memory 5 drives a RAMDAC (Random Access Memory for a Digital Analog Converter) 7 via bus 6, which in turn provides a monitor (not shown) with the color signals R (red), G (green) and B (blue).

In practical applications the data processing circuit 1 will be coupled via a buffer 9 and access logic 10 to a host processor (not shown). The configuration of FIG. 1 is preferably further provided with an instruction RAM 11 which is coupled via a bus 12 to the data processing circuit 1 as well as via a buffer 112 in which registers and drive means are incorporated. A clock means 13 provides the diverse components of the configuration with clock signals while a circuit 14 is included in the configuration for the video timing. A video input circuit 15 is preferably connected to the bus 6 for feeding video signals to the image memory 5.

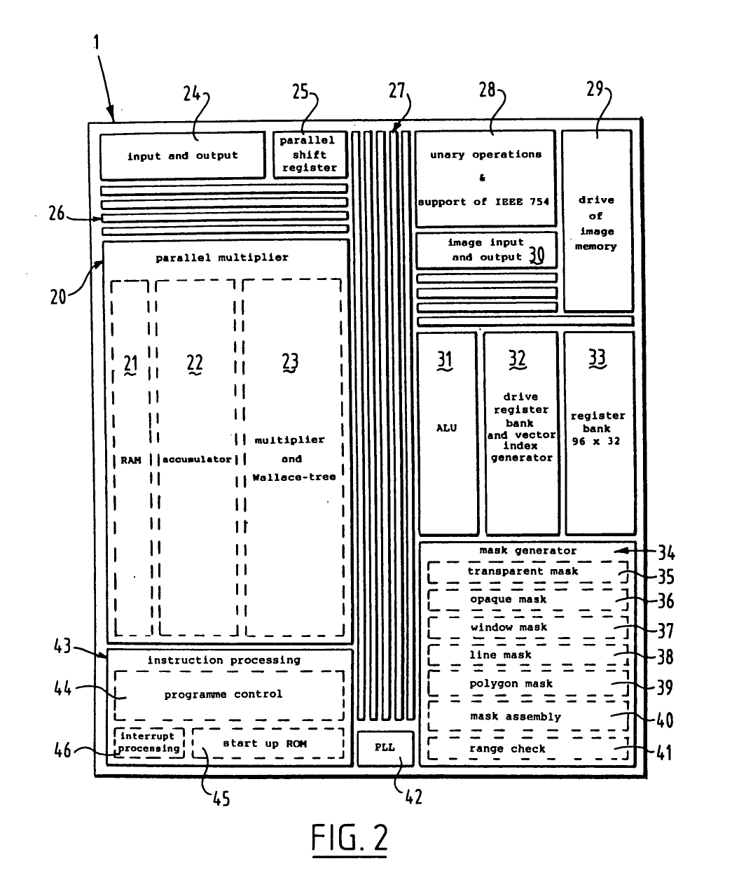

The structure of the data processing circuit is shown schematically in FIG. 2 and comprises a parallel multiplier 20 which comprises a RAM 21, an accumulator 22 and a Wallace tree 23. The data processing circuit also comprises a data input and output circuit 24, a parallel shift register 25, a bus structure 26, a circuit 28 for unary operations, a circuit 29 for driving the image memory, a circuit 30 for image input and output, an arithmetic logic unit 31, a circuit 32 for driving the register bank and a vector index generator, a register bank 33, a mask generator 34 which comprises a transparent mask 35, an opaque mask 36, a window mask 37, a line mask 38, a polygon mask 39, a mask assembly means 40 and a range check 41, a circuit with phase-locked loop 42 and a circuit 43 for instruction processing which comprises a program control 44, start-up ROM 45 and an interrupt processing means 46.

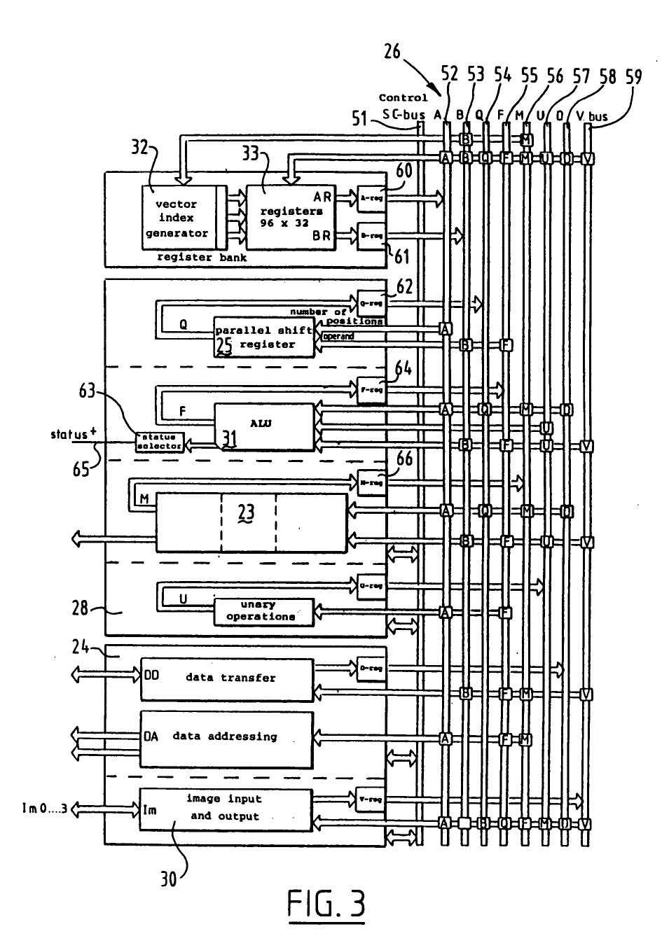

The bus structure 26 (FIG. 3) comprises a control SC-bus 51, an A-bus 52, a B-bus 53, a Q-bus 54, an F-bus 55, an M-bus 56, a U-bus 57, a D-bus 58 and a V-bus 59, each of which is, for instance, 32 bits wide. Each of several functional units of data processing circuit 1 drives its own output bus and has a separate, dedicated output (bus) register/driver for its bus, which can be read in the following cycle by various other functional units. For example, multiplier 23 drives the M-bus 56 using its bus register, M-reg 66; ALU 31 drives the F-bus 55 using its bus register, F-reg 64; shift register 25 drives the Q-bus 54 using its bus register, Q-reg 62; register bank 33 drives the A-bus 52 and B-bus using bus registers, A-reg 60 and B-reg 61, respectively; image input and output circuitry 30 drives the V-bus using its bus register, V-reg; and so forth. This approach allows parallel processing for all of the functional units.

The register bank 33 is connected via output registers 60 and 61 to the A-bus and B-bus respectively. Register bank 33 contains ninety-six inputs which are single 32 bit, double 16 bit or quadruple 8 bit words. Three ports enable simultaneous performance of two read actions and a write action. Sixty-two of the ninety-six registers are directly accessible. The remaining thirty-two inputs are addressed via the vector index generator 32 which can generate a maximum of 12 locations per cycle (i.e., four byte sections for each of the three ports, since each word segment can be selected separately within the registers).

The parallel shift register 25 is designed such that it can shift 32 bits of data anywhere from 1 to 32 positions to the left or right in one clock cycle based on the information received via the A-bus 52. The information can be grouped into one, two or four sections of 32, 16 and 8 bits respectively. The shift can take place logically (unsigned), numerically (signed) and rotatingly. The operands are received from the B-bus 54 or the F-bus 55. The parallel shift register 25 is connected via a register 62 to the Q-bus 54. FIG. 8 schematically shows an example of a two step rotation of a 32 bit word (consisting of two 16-bit bytes) through 11 bits in a positive direction by way of four 8 bit rotations and eight 4 bit crossings.

With reference to FIG. 3, the arithmetic logic unit 31 (ALU) is connected to the A-bus 52, the Q-bus 54, the M-bus 56, the D-bus 58, the U-bus 57, the B-bus 53, the F-bus 55, again to the U-bus 57 and the V-bus 59. All the usual logic operations of a conventional ALU can be performed by the ALU 31 of the present invention in addition to numerical functions such as addition, subtraction, increment and decrement. The ALU 31 is further provided with a so-called parametric logic function. On the basis of the content of an 8 bit register, the ALU 31 can perform a random combination of 256 possible logic operations on 3 operands. The standards for X-window and MS-windows specify that logic and graphic operations must be possible in any combination. The parametric function can also be used to realize shifting, masking, combining or comparing operations in a single clock cycle.

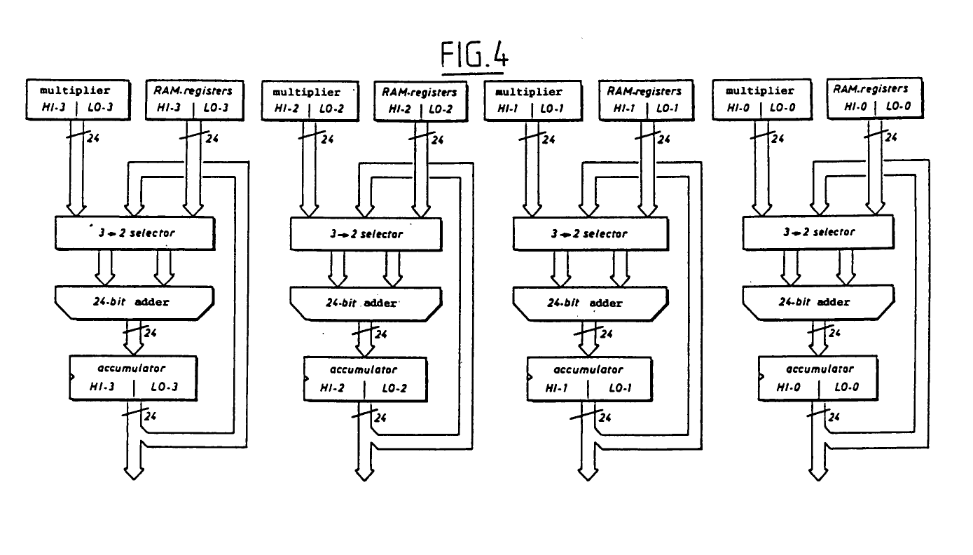

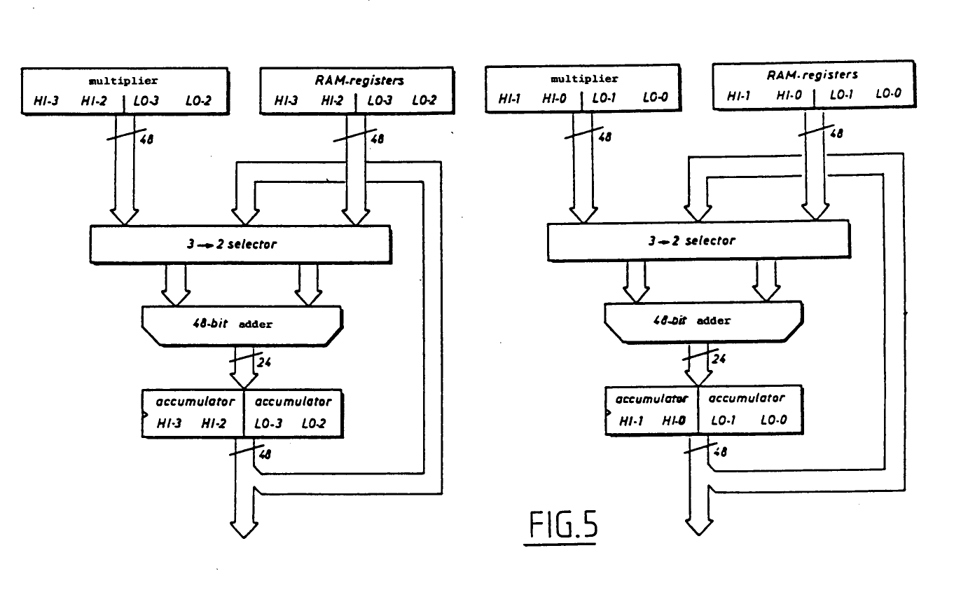

The ALU 31 can be adjusted as a single, double or quadruple parallel unit for 32, 16 and 8 bit operands respectively. The data coming from the A-, Q-, - - - or D-buses determines the selection of the size of the operands to be processed. A mode selector 63 is connected to the ALU 31 and generates a status signal on output 64. The ALU 31 is further connected to the F-bus 55 via an output register 64. FIG. 4 shows a functional diagram of the ALU for a parallel quadruple operation on operands of 24 bits, while FIG. 5 shows a functional diagram of a double operation with 48 bit operands. In FIG. 5, two selectors and two accumulators, each of 8 bits, are combined.

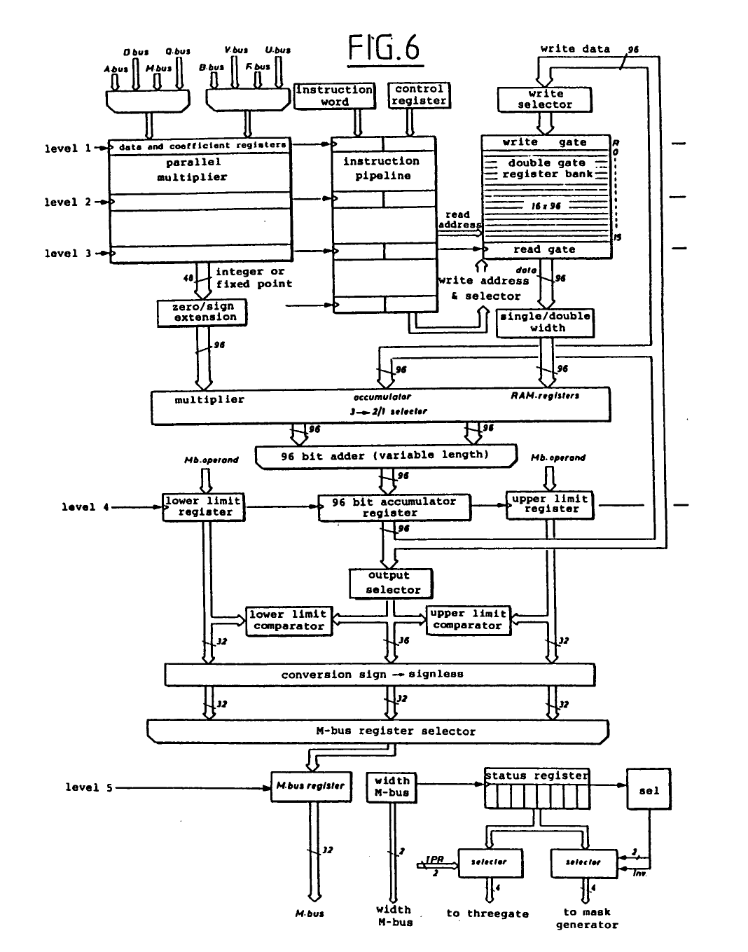

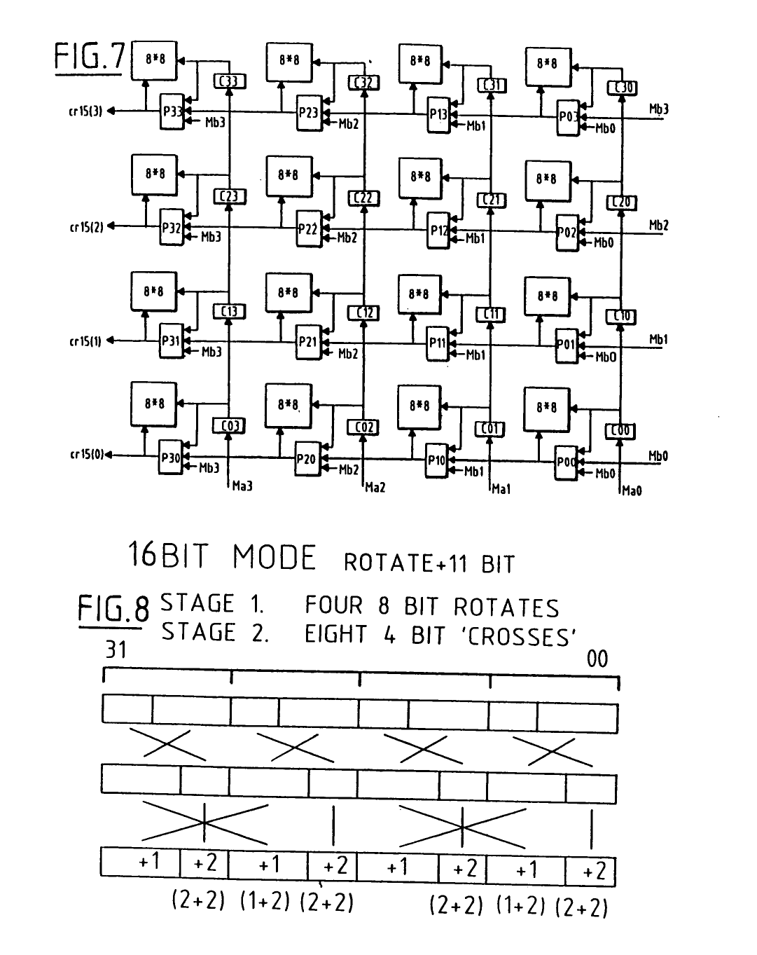

The multiplier 23 is embodied as pipeline with five clock cycles. The multiplier is capable of performing pipeline operations on 32 bit, 16 bit and 8 bit words. All possible multiplication operations with numbers, signed and unsigned, or a combination thereof, in addition to execution of the multiplication of 16 bit complex numbers and 8 bit matrices with vectors is possible due, inter alia, to the presence of a Wallace tree (FIG. 7). The multiplier operates internally with 48 bit results or double 24 bit or quadruple 12 bit values, two of which are transported simultaneously via 96 bit data channels. FIG. 6 shows a functional diagram of the multiplier with five clock levels. The multiplier is connected to the M-bus 56 via an output register 66.

The circuit for unary operations 28 converts data, for instance, binary to unary (linear), indicates the position of the most significant bit, determines the absolute value of a sign and reverse the bit sequence of a word. Circuit 28 can operate on a word of 32, 16 or 8 bits.

The mask generator 24 has a number of independent sub-units. The window mask 37 determines which regions the other operations must fall. The circuit 41 for range checking operates on the basis of pre-defined patterns and, therefore one of its most important applications is generating letter characters. The circuit 41 also serves to check three-dimensional pixel data, such as depth and color.

The line mask 38 generates a horizontally defined pattern between a predetermined beginning and end. The line mask 38 can generate up to four lines simultaneously and supports, for instance, the creation of polygons. A shape along a horizontal line of the image can be produced using the line mask 38, when no interruptions occur along the line.

The polygon mask 39 serves to generate elements for which the line generator is not suitable, for instance, Chinese characters. The polygon mask 39 defines the number of contour transitions on the horizontal lines passing through a relevant pixel.

The mask assembly 40 performing the function of overlaying diverse masks. The results from the mask assembly 40 is transmitted to the respective transparent and/or opaque masks 35, 36 where the actual image for display is created. The transparent and opaque masks 35, 36 can both contain a maximum of 128 pixels in a matrix of 4×32.

The circuit for data input and output 24 is connected to a 32 bit data channel and a 32 bit address bus. The range for addressing comprises 32 Mbyte.

The entry of instructions takes place under the control of the program control unit 44. With a 22 bit address, a following instruction word is continuously assigned which is subsequently entered via a separate 64 bit bus. The program memory can have a size of 4M×64 bits.

The drive of the image memory 29 is adapted to generate an address on the basis of an X/Y position so that any random image segment can be addressed on the basis of its location and the image in the image memory. The image memory is also suitable for storing other data banks such as lists and data banks with graphic elements.

When a clock frequency of 66 MHZ is used for a data processing circuit according to the present invention, it is possible to operate system such that the access time for the memory is 70 ns.

The data processing circuit 1 can be programmed in a higher program language, such as C, so that it is easily programmed, as in RISC and CISC processing units. The data processing circuit 1 can be programmed with instructions according to the RISC concept as well as with the CISC instructions of a personal computer. In order to achieve a large increase in speed for graphic applications, the programmer can program all functions of the data processing circuit 1 at a lower level via an instruction field of 64-bits. The ALU 31 and the multiplier unit can be set to parallel operations, whereby the speed for graphic applications can be increased by a factor of 4-20 as compared to existing RISC processors. For a particular application, a programmer will set a “once-only” series of instructions and control registers. Subsequently, the programmer will start the processor with one command, hereafter the processor independently processes the pixel flows.

As example of the speed increase which can be gained by way of the present invention, algorithm consisting of five instructions for rotating and interpolating a color image is presented which can accommodate a total of 38 instructions, that is:

read 2×16 bit register;

increment 2×16 bit register address;

read 1×10 bit constant;

shift 2×16 bit word;

read 2×16 bit constant;

add 2×16 bit value;

read out 4×8 bit 2D memory data;

read out 4×8 bit image memory data;

increment 1×32 bit image memory address;

multiply 4×8 bit value;

read 4×12 bit accumulator register;

accumulate 4×12 bit value write 4×12 bit accumulator register; and

increment 2×5 bit register address accumulator.

The data processing circuit according to the present invention can be built into specific equipment but can also be embodied as an extension card for a personal computer. Owing to the flexible utilization of the hardware, even at lower clock speeds than, for instance, 200 MHZ, which is currently among the highest, from 5 to 20 times improvement in image processing speed can be obtained. This makes the data processing circuit according to the present invention suitable for real-time video operations and so-called virtual reality.

A product specification entitled, “IMAGINE: The Image Engine—Documentation & User's Manual”, version 2.80, Arcobel Graphics B.V. of Hertogenbosch, Netherlands, March 1994, which is a part of the parent application and which is incorporated herein by reference, provides additional details of embodiments of the data processing circuit 1, including the following:

The IMAGINE instruction word format has two main types: the Data Processing format and the Special Function format. The Data processing format inhibits the Hierarchical Instruction Set stemming from the HISC principles. All the data processing units have their own small instruction field within the 64 bit instruction word. All these units can execute instructions in parallel. This model allows an interface between two different worlds of computing. At one side it is directly compatible with the world of RISC (and CISC) processors which are organised around an instruction execution pipeline. The Risc instruction ripples through the stages of this pipeline after being fetched from cache memory. The typical sequence contains a Read register stage, Execute stage, and Write back register stage.

The typical register based RISC instruction:
add_(res, op1, op2) {res=op1+op2}

is translated as follows into the native machine language of the IMAGINE: three independent operations are combined into a single graph; the read register, execute and write register operation.
AB=rd(op1, op2)−>F=add(A,B)−>wr(res, F)

The Assembler contains an intelligent pipeline optimiser which places each pipeline stage in an optimal way. Alternatively it leaves the exact placement to the programmer.

This extra degree of freedom comes at the cost of a longer instruction word (64 bit instead of 32 bit). The great advantage is that the model now allows other much more efficient ways of processing.

The Bus Register/Drivers

All data processing and I/O units contain a ‘bus-register’ which contents can be used by other units.

A bus: three port register file read port

B bus: three port register file read port

Q bus: the barrel shifter result.

F bus: the ALU result.

M bus: the multiplier/accumulator result.

U bus: the unary function unit result.

D bus: the data memory I/O register.

V bus: the image memory I/O register.

These bus registers are visible in the native instruction language:
AB=rd(r43,cr36)−>F=add(A,B)−>wr(cr36, F);

What is claimed is:

1. A processor comprising:
a plurality of functional units, including a multiplier unit and an arithmetic logic unit, to execute operations defined from an instruction set of the processor, wherein each of the plurality of functional units has an output that can be explicitly referenced in instructions defined from the instruction set.

2. A processor as recited in claim 1, further comprising:
a plurality of dedicated output buses, one for each of the functional units; and
a plurality of bus registers, each coupled to store the output of only a corresponding one of the plurality of functional units and each coupled to only a corresponding one of the plurality of dedicated output buses.

3. A processor as recited in claim 2, wherein each of the dedicated output buses is coupled to an input of at least one other of the plurality of functional units.

4. A processor as recited in claim 1, wherein the instruction set has a hierarchy of instruction levels, each of which can be used by a programmer to define instructions for the processor, the hierarchy of instruction levels including:
a RISC/CISC assembly code level; and
a free pipeline assembly code level.

5. A processor as recited in claim 4, wherein the free pipeline assembly code level comprises a native machine language of the processor.

6. A processor as recited in claim 4, wherein the plurality of hierarchical instruction levels further include a vector processing assembly code level.

7. A processor as recited in claim 6, further comprising a plurality of special use control registers, wherein the plurality of hierarchical instruction levels further comprise a level for using the special use control registers.

8. A processor comprising:
a multiplier unit adjustable to multiply integer data words of any of a plurality of different lengths in response to instructions defined in an instruction set of the processor, the plurality of different lengths being integer multiples of each other, wherein the instruction set has a hierarchy of instruction levels, each of which can be used by a programmer to define instructions for the processor;
an arithmetic logic unit (ALU) adjustable to perform arithmetic operations on integer data words of any of the plurality of different lengths in response to instructions defined in the instruction set;
a shift register to perform shift operations in response to instructions defined in the instruction set;
a plurality of dedicated output buses, one for each of the multiplier unit, the ALU, and the shift register; and
a plurality of bus registers, each coupled to an output of a separate corresponding one of the multiplier unit, the ALU, and the shift register and to a separate corresponding one of the plurality of dedicated output buses, the bus registers to hold outputs of the multiplier unit, the ALU, and the shift register, respectively,
wherein the outputs of the multiplier unit, the ALU, and the shift register can be explicitly referenced by instructions defined from the instruction set.

9. A processor as recited in claim 8, wherein the hierarchy of instruction levels includes:
a RISC/CISC assembly code level;
a free pipeline assembly code level; and
a vector processing assembly code level.

10. A processor as recited in claim 9, wherein the free pipeline assembly code level comprises a native machine language of the processor.

11. A processor as recited in claim 9, further comprising a plurality of special use control registers, wherein the plurality of hierarchical instruction levels further comprise a level for using the special use control registers.

12. A processor as recited in claim 8, wherein the ALU has at least three operand inputs, further comprising:
a control register containing a plurality of bits which define a three port parametrised logic function to be performed on the at least three operand inputs, the ALU receiving a plurality of bits from the control register to execute the three port parametrised logic function.
